(19) United States
(12) Patent Application Publication
(10) Pub. No.: US 2026/0319563 A1
(43) Pub. Date: Oct. 15, 2026

(54) DATA PROCESSING METHOD AND DEVICE

(71) Applicant: Lenovo (Beijing) Limited, Beijing (CN)

(72) Inventor: Yi ZHANG, Beijing (CN)

(21) Appl. No.: 19/311,496

(22) Filed: Aug. 27, 2025

(30) Foreign Application Priority Data
Aug. 28, 2024 (CN) 202411195615.4

(51) Int. Cl. G06F 1/3228

(52) U.S. Cl. CPC G06F 1/3228

(57) ABSTRACT

The present disclosure discloses a data processing method and device, the method comprising: in response to a first device and a second device being in a connected state, a first processor of the first device loads a second model stored in the second device to a second processor of the second device; the second model running on the second processor may process data output by the first device.

### RELATED APPLICATION(S)

This application claims priority to Chinese Patent Application No. 2024111956154 filed with China National Intellectual Property Administration, on Aug. 28, 2024, which is incorporated herein by reference in entirety.

### FIELD OF THE TECHNOLOGY

The present disclosure relates to a field of data processing technology, and in particular to a data processing method and device.

### BACKGROUND

Some electronic devices may use data processing models (such as AI models based on artificial intelligence technology) to process various data. When running the model, the device may perform a large amount of calculations. These electronic devices may be connected to auxiliary devices containing processors as hosts, and use the computing power of the auxiliary devices to perform calculations.

### SUMMARY

In one aspect, the present disclosure provides a data processing method performed by a first processor of a first device. The method includes: in response to the first device and a second device being in a connected state, loading a second model stored in the second device to a second processor of the second device, where the second model running on the second processor processes data output by the first device.

In another aspect, the present disclosure provides an electronic device (first device). The first device includes: a first memory storing computer program instructions; and a first processor coupled to the first memory and configured to execute the computer program instructions and perform: in response to the first device and a second device being in a connected state, loading a second model stored in the second device to a second processor of the second device, where the second model running on the second processor processes data output by the first device.

In yet another aspect, the present disclosure provides a non-transitory computer-readable storage medium storing computer program instructions executable by at least one processor to perform: in response to a first device and a second device being in a connected state, loading a second model stored in the second device to a second processor of the second device, where the second model running on the second processor processes data output by the first device

### BRIEF DESCRIPTION OF THE DRAWINGS

In order to more clearly illustrate the technical solutions in certain embodiments of the present disclosure, the accompany drawings are introduced and described. For ordinary technicians in this field, other drawings may be obtained based on the accompanying drawings without creative work.

FIG. 1 is a flow chart of a data processing method provided in certain embodiments of the present disclosure;

FIG. 2 is a schematic diagram of a connection relationship between a first device and a second device provided in certain embodiments of the present disclosure;

FIG. 3 is a schematic diagram of a connection relationship between a first device and a second device provided in certain embodiments of the present disclosure; and

FIG. 4 is a structural schematic diagram of a data processing device provided in certain embodiments of the present disclosure.

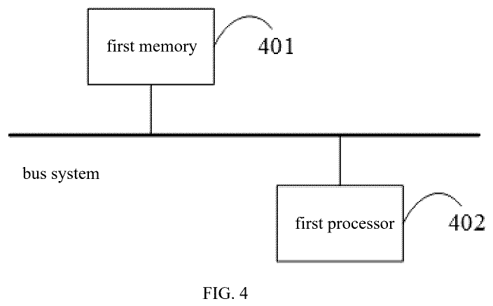

### DETAILED DESCRIPTION

Some electronic devices may use data processing models (such as AI models based on artificial intelligence technology) to process various data. When running the model, the device may perform a large amount of calculations. These electronic devices may be connected to auxiliary devices containing processors as hosts, and use the computing power of the auxiliary devices to perform calculations. For example, an auxiliary device with an embedded neural network processor (NPU) may be connected to a computer, and the computer may use the former's NPU to process model-related operations.

The auxiliary device may include a memory, which stores a data processing model suitable for the processor of the auxiliary device to run, but the processor of the auxiliary device in certain of these existing technologies is generally a passive device and does not have the ability to actively load the data processing model from the memory, resulting in the processor of the auxiliary device being unable to use the model stored in its memory to process data.

The following descriptions reflect certain embodiments of the present disclosure, not necessarily all of the embodiments. Based on certain embodiments in the present disclosure, other embodiments obtained by ordinary technicians in this field without creative work are within the scope of protection of the present disclosure.

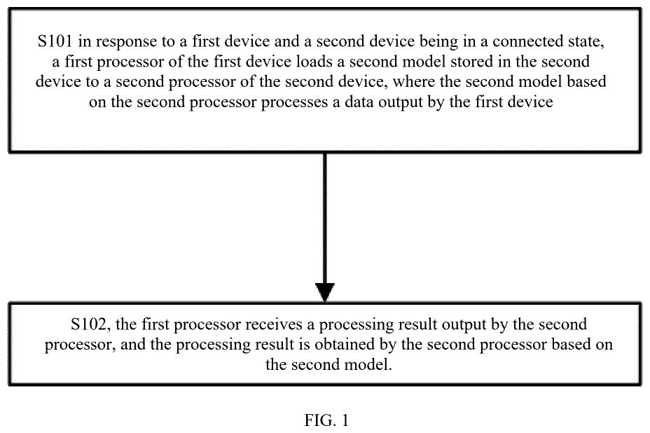

Certain embodiments of the present disclosure provide a data processing method. FIG. 1 depicts a flowchart of the method. The method may include the following steps.
S101, in response to a first device and a second device being in a connected state, a first processor of the first device loads a second model stored in the second device to a second processor of the second device, where the second model based on the second processor processes a data output by the first device.

The first device and the second device may be any two electronic devices each including a processor.

In certain embodiments, the first device may be a host device, such as a laptop, a tablet, or the like, and the second device may be an auxiliary device for providing computing power support to the host device and assisting the host device in running various AI models.

The first device may be installed with an operating system, through which the first device may read data from a memory and load the read data to other devices.

The first processor and the second processor may be the same processor, for example, both the first processor and the second processor may be a central processing unit (CPU).

The first processor and the second processor may be two different processors, for example, the first processor may be a central processing unit (CPU) of the first device, and the second processor may be a graphics processing unit (GPU) of the second device, or an embedded neural network processor (NPU) of the second device.

The first device may include several interfaces, and the second device may establish a connection with the first device through any interface of the first device. The first processor may detect the signals of each interface of the first device in real time. When a signal characterizing the access of the second device is detected at any interface, the first processor may determine that the second device and the first device are in a connected state.

The second device may store any number of second models. The second model may be any data processing model that may be used to process data. As an example, these second models may be AI models built based on artificial intelligence technology, such as neural network models, deep learning models, or the like.

For different types of processors, the AI models suitable for running on the processor are generally different. The second model stored in the second device may include an AI model suitable for running on the second processor. As an example, when the second processor is a GPU, the second model may include a GPU quantization model suitable for running on the GPU, and when the second processor is an NPU, the second model may include an NPU quantization model suitable for running on the NPU.

The second device may include any number of second memories, and the second model may be stored in these second memories. The second memory may include a solid-state drive (SSD) or other types of memory.
S102, the first processor receives a processing result output by the second processor, and the processing result is obtained by the second processor based on the second model.

When the second model is not loaded into the second processor, the second processor may not process data by running the second model.

After the second model is loaded into the second processor, the second processor may run the second model, process the data to be processed sent by the first device through the second model, and output the corresponding processing result.

In certain embodiments, the first processor may transmit image data to the second processor, and the second processor processes the image data based on the loaded second model, and feeds back the processing result to the first processor, and the processing result may include the object recognition result of the image data, or may include the image data after optimization processing (such as noise reduction, brightness improvement, or the like).

The first processor may transmit text data to the second processor, and the second processor processes the text data based on the loaded second model, and feeds back the processing result to the first processor, and the processing result may include the content summary of the text, or may include the text content in the text related to the question raised by the user.

The beneficial effects of these certain embodiments are:
When the second device is connected to the first device, the first processor of the first device actively loads the second model stored in the second device to the second processor of the second device. Thus, even when the second processor is a passive device that does not have the ability to actively load models, the second processor may run the second model stored in the second device itself and process the data output by the first device according to the second model, thereby solving the problem that the processor of the auxiliary device may not use the data processing model stored in its memory to process the data of the host device.

In certain embodiments, in order to avoid conflicts between the AI model run by the first device and the second model loaded into the second processor, the first processor may also disable the first model of the first device as follows:
The first processor determines the first model stored in the first device, the function of the first model meets the same conditions as the function of the second model, and the first model may be run based on the processor of the first device;
The first processor sets the first model to a disabled state, and the model in a disabled state may not be loaded into the processor.

The first model may include an AI model whose corresponding function is the same as the function of the second model among the multiple AI models stored in the first memory. For example, when the second model is an AI model for processing an image and identifying an object displayed in the image, then the first model may include an AI model stored in the first memory that is also used to identify an object displayed in the image; when the second model is an AI model for processing text data and outputting a content summary of the text data, then the first model may include an AI model stored in the first memory that is also used to process text data and output a content summary of the text data.

The first memory includes a memory of the first device.

The first model may include an AI model suitable for running on the first processor of the first device, for example, the first device may include a graphics processor, and the first model may include a GPU quantization model whose function satisfies the same conditions as the function of the second model and is suitable for running on a GPU.

After the first processor determines the first model, the first processor may set the first model to a disabled state, thereby prohibiting the first processor of the first device from loading and running the first model.

The process of disabling the first model may be performed before the first processor loads the second model to the second processor. That is, after determining that the first device and the second device are in a connected state, the first processor may set the first model to a disabled state, and then load the second model to the second processor according to step S101 of FIG. 1.

The advantage of disabling the first model is that when the second model loaded by the second processor is used to process data, disabling the first model having the same function may avoid the situation where the first model and the second model having the same function process data at the same time.

In certain embodiments, after disabling the first model, the first processor may continuously or periodically detect the connection status of the first device and the second device, and enable and load the first model according to the connection status of the first device and the second device as follows:
In response to the first device and the second device switching from a connected state to a non-connected state, the first processor sets the first model to an enabled state, and the first model in the enabled state may be loaded to the first processor;
The first processor loads the first model to process the data of the first device according to the first model.

When the second device is connected to the first device, the second device may be removed from the interface of the first device based on the user's operation. The second device and the first device switch from a connected state to a non-connected state. In order to continue to implement the function implemented by the second model of the second device, the first processor may enable the previously disabled first model, that is, set the first model to an enabled state, and then load the first model to the first processor in the first device for running the model, so that the first device may instead implement the processing function according to the first model after the second device is removed.

The first processor may continuously or periodically detect the interface in the first device for accessing the second device. When the signal of the interface changes from indicating that the second device is connected to indicating that the second device is not connected, the first processor may determine that the first device and the second device are switched from a connected state to a non-connected state, and then enable and load the first model.

The first processor loads the first model, which may be performed by:
When the first model is an AI model suitable for the first processor to run, the first processor may load the first model into the cache of the first processor, so that the first processor may process data according to the first model;
When the first model is an AI model suitable for other processors of the first device to run, for example, the first processor is the CPU of the first device, and the first model is a GPU quantization model suitable for the GPU of the first device to run, the first processor may load the first model into the cache of the processor suitable for running, for example, into the cache of the GPU of the first device, and use the corresponding processor to run the first model.

The beneficial effect of these certain embodiments is that after the second device is removed, the first processor may timely enable and run the first model locally on the first device to realize the function previously realized by the second device.

In certain embodiments, the multiple AI models stored in the first memory may include a first model having the same function as the second model, and may also include a third model having different function from the second model.

When the second processor processes the data output by the first device according to the second model, the first processor may also load the third model stored in the first memory to the corresponding processor in the first device, thereby running the third model on the first device, so that the first device may use the second model and the third model to process different data at the same time and realize different functions.

In certain embodiments, the third model may include a GPU quantization model in the first memory suitable for GPU operation of the first device and having a function different from the second model. The first processor may load the third model to the GPU of the first device and load the second model to the NPU of the second device, thereby using the third model of the GPU and the second model of the NPU to process data. The third model and the second model may be run simultaneously.

The functions of the second model and the third model may be unrelated to each other. For example, the second model may be an NPU quantization model for processing text data, and the third model may be a GPU quantization model for processing image data.

The functions of the second model and the third model may also have a certain correlation. For example, the function of the second model may be to extract text content related to a question raised by a user in text data, and the function of the third model may be to generate an answer to a question based on the input text data.

The beneficial effect of these embodiments is that the first device may run multiple AI models with different functions on the first processor of the first device itself and on the second processor of the second device, respectively, thereby improving the processing capability of the first device and enabling the first device to process multiple different tasks.

The first processor may determine the first model in the AI model stored in the first device in the following manner:
Obtain the model name of the first model stored in the first device and the model name of the second model;
Determine the model stored in the first device and having the same model name as the second model as the first model.

After determining that the first device and the second device are in a connected state, the first processor may first read the model name of the first model stored in the first memory and the model name of the second model, and then compare the names of the two. When it is found that the model name of the first model in the first memory is consistent with the model name of the second model, then determine that the first model in the first memory is the first model. In certain embodiments, the first model is an AI model.

In certain embodiments, the second model stored in the second memory may be an NPU quantization model with a model name of llama3. When it is determined that the first device and the second device are in a connected state, the first processor compares the model name of the GPU quantization model stored in the first memory with the model name of the second model, and finds that there is a GPU quantization model with a model name of llama3 in the first memory, so the first processor may determine that the GPU quantization model with a model name of llama3 is the first model.

In certain embodiments, after determining the AI model in the first memory that has the same model name as the second model, the first processor may also compare the version of the model with the version of the second model.

When the versions of the two models are the same, the first processor may determine the AI model with the same version and the same model name as the second model as the first model.

When the versions of the two are not the same, the first processor may perform the following steps to update the second model to the same version, and then disable the first model with the same version and the same model name stored in the first memory.

Where the version of the second model is inconsistent with the version of the first model, the second model stored in the second device is updated, and the version of the updated second model is consistent with the version of the first model.

In certain embodiments, after the first processor determines that the first device and the second device are in a connected state, the model name comparison and version comparison steps may be performed, and the second model may be updated when the version comparison is inconsistent, so that when the second model is loaded, the updated second model stored in the second device is loaded to the second processor.

In certain embodiments, when it is determined that the first device and the second device are in a connected state, the first processor may find out through the model name and version of the AI model stored in the first memory and the second memory that the first memory stores a 4th version of the llama3 GPU quantization model, and the second memory stores a 3rd version of the llama3 NPU quantization model. Since the versions of the two are inconsistent or different from each other, the first processor may update the 3rd version of the llama3 NPU quantization model stored in the second memory to the version of the corresponding model in the first memory, that is, update the model stored in the second memory to the 4th version of the llama3 NPU quantization model. Then, the first processor determines that the 4th version of the llama3 GPU quantization model is the first model, sets the first model to a disabled state, and then the first processor determines the 4th version of the llama3 NPU quantization model in the second memory as the updated second model, and loads the updated second model from the second memory to the second processor.

The first processor may update the second model when it is determined that the version of the second model is inconsistent with the version of the first model, or may update the second model immediately after determining that the first device and the second device are in a connected state, or may update the second model when other conditions are met. The present disclosure does not limit the conditions for triggering the update.

In certain embodiments, after determining that the first device and the second device are in a connected state, in order to prevent the second model from being deleted or modified, the first processor may set the state of the second memory as follows:
In response to the first device and the second device being in a connected state, set the second memory of the second device to a non-editable state.

The non-editable state may have the following characteristics:
In certain embodiments, when the second memory is in the non-editable state, the access path information of the second memory may not be displayed on the operation interface of the first device, thereby preventing the user from accessing and editing the second model stored in the second memory through the operation interface;
In certain embodiments, when the second memory is in the non-editable state, the first processor may close the data writing and deleting permissions of the second memory and only enable the reading permissions of the second memory. The first processor may only load the second model stored in the second memory to the second processor, but may not write data to the second memory or delete the original data in the second memory.

After the second memory is set to be non-editable, when the second model may be updated, the first processor may update it as follows:
Obtain the updated second model;
Set the second memory to an editable state;
In response to the update operation instruction, replace the second model stored in the second memory in the editable state with the updated second model;
Set the second memory back to a non-editable state.

In certain embodiments, the first device may establish a communication connection with the server providing the second model, send a request to the server to obtain the latest version of the second model, and then receive the latest version of the second model transmitted by the server, and determine the received second model as the updated second model.

In order to perform the update, the first processor may set the second memory from a non-editable state to an editable state.

The editable state may have the following characteristics:
In certain embodiments, when the second memory is in an editable state, the access path information of the second memory may be displayed on the operation interface of the first device, so that the user may manually select the second memory for storing the updated second model through the access path information;
In certain embodiments, when the second memory is in an editable state, the first processor may enable the data write and delete permissions of the second memory, so as to delete the original low-version second model of the second memory based on the write and delete permissions, and write the updated second model.

After the first processor sets the second memory to an editable state, the user of the first device may perform an update operation on the second memory based on the displayed access path information. The first processor may delete the outdated version of the second model stored in the second memory in response to the update operation instruction generated by the update operation, and write the obtained updated second model into the second memory, thereby performing the update of the second model.

After the update is performed, the first processor may set the second memory to a non-editable state again to prevent the updated second model from being deleted or modified.

Depending on the structure of the second device, there may be different connection relationships between the first device and the second device, and correspondingly, the first processor may load the second model to the second processor in different ways.

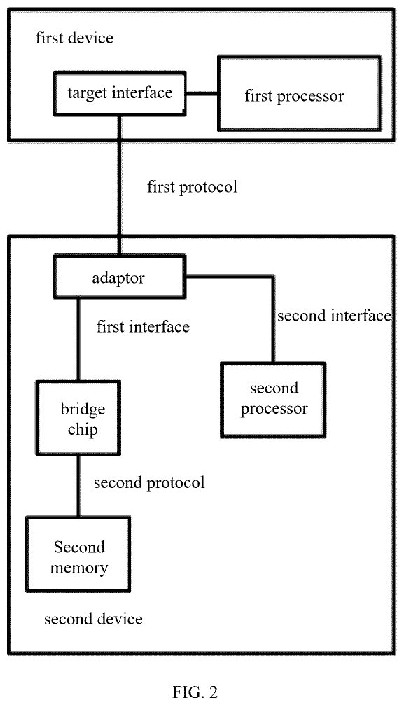

In certain embodiments, and in view of FIG. 2, the second device may include an adapter, a bridge chip, a second memory, and a second processor.

The first processor is connected to the adapter through an interface supporting the first protocol, and is connected to the second memory and the second processor through the adapter. The first device may include multiple interfaces supporting different data transmission protocols, which may include a target interface supporting the first protocol.

When the first device and the second device are connected, the adapter is connected to the target interface of the first device through the first protocol, and the adapter may provide a first interface based on the first protocol to the inside of the second device, and may also convert the first protocol of the target interface into the second protocol, thereby providing a second interface based on the second protocol to the inside of the second device.

The first protocol and the second protocol may be any two different data transmission protocols.

Inside the second device, the second processor supporting the second protocol may be directly connected to the first interface provided by the adapter. Through this connection mode, the first processor may identify the second processor as a device accessed based on the second protocol, and may perform data transmission with the second processor using the second protocol.

The second memory supporting the second protocol may be connected to the first interface provided by the adapter through a bridge chip, and the bridge chip is used to convert the first protocol supported by the first interface into the second protocol supported by the second memory. Through this connection mode, the first processor may identify the second memory as a device accessed based on the first protocol, and may perform data transmission with the first protocol and the second memory.

In certain embodiments, the first protocol may be a USB protocol, the second protocol may be a PCIe protocol, the target interface based on the first protocol may be a USB interface of the first device, and the adapter may be any chip that may realize the mutual conversion between the USB protocol and the PCIe protocol, for example, it may be a thunderbolt5 controller. Through the connection mode shown in FIG. 2, the first processor may identify the second processor as a PCIe device, that is, as a device belonging to the motherboard of the first device, and identify the second memory as a USB storage device.

The advantage of connecting the first device and the second device based on the above connection mode is that, through the above connection mode, the second memory and the second processor may respectively transmit data with the first processor through different transmission buses corresponding to different protocols, thereby improving the data transmission efficiency between the second memory and the first processor, and between the second processor and the first processor.

In certain embodiments, based on the connection mode shown in FIG. 2, the process of the first processor loading the second model into the second processor may include:
Sending a first instruction to the second device so that the second memory of the second device is in a first power consumption mode, the second processor is in a second power consumption mode, and the power consumption corresponding to the first power consumption mode is greater than the power consumption corresponding to the second power consumption mode;
When the second memory of the second device is in the first power consumption mode and the second processor is in the second power consumption mode, the second model stored in the second memory is read into the first memory of the first device;
Sending a second instruction to the second device so that the second memory is in the second power consumption mode and the second processor is in the first power consumption mode;
When the second memory is in the second power consumption mode and the second processor is in the first power consumption mode, the second model is written from the first memory to the cache of the second processor.

The first instruction may be an instruction to read the second model from the second memory.

In response to receiving the first instruction, the second memory may set its own mode to the first power consumption mode with higher power consumption, such as setting it to the working mode, and the data reading and writing functions of the second memory in this mode may be used.

In response to receiving the first instruction, the second processor may set its own mode to the second power consumption mode with lower power consumption, such as setting it to the low power standby mode, and the data processing function of the second processor in this mode may be disabled, and only the function of responding to external instructions may be enabled.

Based on the configuration of the power consumption mode, the first processor may read the second model from the second memory and store the read second model in the first memory of the first device.

After reading the second model, the first processor may send a second instruction to the second device, and the second instruction may be an instruction indicating that the first processor loads the second model to the second processor.

In response to receiving the second instruction, the second memory may set its own mode to a second power consumption mode with lower power consumption, such as a low power standby mode. The data read and write function of the second memory in this mode may be turned off, and the first processor may not read data from the second memory.

In response to receiving the second instruction, the second processor may set its own mode to a first power consumption mode with higher power consumption, such as a normal working mode, and the data processing function of the second processor in this mode may be enabled.

Based on the configuration of the above power consumption mode, the first processor may write the second model from the first memory to the cache of the second processor.

The method of writing the second model into the cache of the second processor is as follows:

In certain embodiments, the first processor may read a part of the model parameters of the second model for the operation from the first memory, write the read model parameters into the cache of the second processor, and the second processor performs the operation task of the second model based on the written model parameters and the data to be processed provided by the first processor. After processing a part of the operation task, the first processor may continue to read another part of the model parameters of the second model for the operation from the first memory, write the read model parameters into the cache of the second processor, and the second processor continues to perform subsequent operation tasks based on the written model parameters, and so on, until the second processor performs all the operation tasks of the second model and outputs the processing results obtained by processing according to the second model.

The cache of the second processor may be a double data rate (DDR) cache or other types of caches. The present disclosure does not cast limit on the type of the cache of the second processor.

The beneficial effects of these embodiments are:
When reading the second model from the second memory, the second processor does not need to perform calculations. Setting the second processor to the second power consumption mode with lower power consumption may reduce the power consumption of the second device; when writing the second model from the first memory to the cache of the second processor, the first processor may not read and write the second memory. Setting the second memory to the second power consumption mode with lower power consumption may reduce the power consumption of the second device.

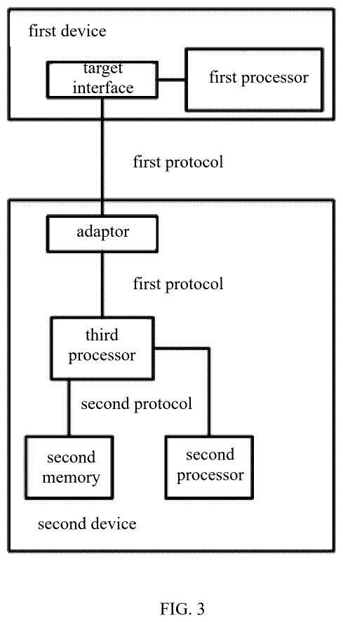

In certain embodiments, the second device may also include a third processor. As shown in FIG. 3, the second device may include a second memory, a second processor, a third processor and an adapter.

In certain embodiments, the second device is connected to the first processor of the first device through the third processor.

As shown in FIG. 3, the connection mode of the third processor and the first processor is that when the first device and the second device are in a connected state, the first processor is connected to the target interface of the first device, the adapter of the second device is connected to the target interface of the first device, and the third processor of the second device is connected to the target interface of the first device through the adapter, so that the first processor and the third processor may communicate through the target interface and the adapter.

The third processor may be used to run the control system. In certain embodiments, the third processor may be a system-on-chip (SoC) or other processors that may run the control system.

The second memory and the second processor are both connected to the third processor, so that the third processor may control the second processor and the second memory based on the running control system.

Based on the above connection relationship, the first processor may load the second model to the second processor in the following manner:

The first processor of the first device sends a third instruction to the third processor, so that the control system loads the second model to the second processor according to the third instruction.

In this loading mode, when the second model may be loaded to the second processor, the first processor may send a third instruction to the third processor to start loading the second model. In response to receiving the third instruction, the third processor loads the second model stored in the second memory into the cache of the second processor, so that the second processor may use the second model to process the data output by the first device.

The beneficial effect of these embodiments is that the second model may be directly loaded from the second memory to the second processor without being read into the first device first, with the performance of the third processor. On the one hand, the loading may be performed relatively faster, and on the other hand, the storage space of the first device may be saved.

Certain embodiments of the present disclosure provide a data processing device, the device is a first device, and the first device may include a first memory 401 and a first processor 402.

The first processor 402 may be used to:
In response to the first device and the second device being in a connected state, load the second model stored in the second device to the second processor of the second device; the second model running on the second processor may process the data output by the first device.

In certain embodiments, the first processor 402 may be used to:
Determine the first model stored in the first device, the function of the first model and the function of the second model meet the same conditions, and the first model may be run based on the first processor;
Set the first model to a disabled state, and the model in the disabled state may not be loaded into the processor.

In certain embodiments, when the first processor 402 determines the first model stored in the first device, it may be used to:
Obtain the model name of the model stored in the first device and the model name of the second model;
Determine the model stored in the first device and having the same model name as the second model as the first model.

In certain embodiments, the first processor 402 may be used to:
In response to the first device and the second device switching from a connected state to a non-connected state, set the first model to an enabled state, and the model in the enabled state may be loaded into the processor;
Load the first model to process the data of the first device according to the first model.

In certain embodiments, the second device includes an adapter, a second memory, and a second processor;
The first processor 402 is connected through an interface supporting the first protocol and an adapter, and is connected to the second memory and the second processor through the adapter;
The adapter is used to convert the first protocol into the second protocol;
The first processor 402 performs data transmission with the first protocol and the second memory;
The first processor 402 performs data transmission with the second protocol and the second processor.

In certain embodiments, when the first processor 402 loads the second model stored in the second device into the second processor of the second device, it may be used to:
Send a first instruction to the second device, so that the second memory of the second device is in the first power consumption mode, the second processor is in the second power consumption mode, and the power consumption corresponding to the first power consumption mode is greater than the power consumption corresponding to the second power consumption mode;
When the second memory of the second device is in the first power consumption mode and the second processor is in the second power consumption mode, read the second model stored in the second memory to the first memory of the first device;
Send a second instruction to the second device, so that the second memory is in the second power consumption mode and the second processor is in the first power consumption mode;
When the second memory is in the second power consumption mode and the second processor is in the first power consumption mode, write the second model from the first memory to the cache of the second processor.

In certain embodiments, the first processor 402 may be used for:
When the version of the second model is inconsistent with the version of the first model, update the second model stored in the second device, and the version of the updated second model is consistent with the version of the first model;
Load the second model stored in the second device to the second processor of the second device, including:
Load the updated second model stored in the second device to the second processor.

In certain embodiments, the first processor 402 may be used for:
In response to the first device and the second device being in a connected state, set the second memory of the second device to a non-editable state;
Obtain the updated second model;
Set the second memory to an editable state;
In response to the update operation instruction, replace the second model stored in the second memory in an editable state with the updated second model;
Set the second memory to a non-editable state.

In certain embodiments, the second device includes a third processor, and the second device is connected to the first processor of the first device through the third processor;

The third processor is used to run the control system;

When the first processor 402 of the first device loads the second model stored in the second device into the second processor of the second device, it may be used to:
The first processor of the first device sends a third instruction to the third processor, so that the control system loads the second model into the second processor according to the third instruction.

The working principle of the data processing device of these embodiments may refer to the relevant steps of the data processing method, and is not repeated for brevity.

Certain embodiments are described in a manner where differences between the embodiments are shown. The same and similar parts between certain embodiments may be referred to each other.

In certain embodiments, the system or device is described by function and is divided into various modules or units. The functions of each unit may be implemented in the same or multiple software and/or hardware.

The technicians in this field may understand that the present disclosure may be implemented by suitable software plus the hardware platform. Based on this understanding, the technical solution of the present disclosure may be embodied in the form of a software product. The computer software product may be stored in a storage medium, such as ROM/RAM, a disk, an optical disk, or the like, and includes a number of instructions for enabling a computer device (which may be a personal computer, a server, or a network device, or the like) to execute the methods described in certain embodiments of the present disclosure.

When applicable, terms such as first, second, third and fourth are used to distinguish one entity or operation from another entity or operation, and do not necessarily require or imply any such actual relationship or order between these entities or operations. Terms such as “include” and “comprise” or any other variants thereof cover non-exclusive inclusion, so that a process, method, article or device including a series of elements includes not only those elements, but also other elements not explicitly listed, or also includes elements inherent to such process, method, article or device. In the absence of further restrictions, the elements defined by the sentence “comprise one . . . ” do not exclude the existence of other identical elements in the process, method, article or device including the elements.

For ordinary technicians in the technical field, improvements and modifications may be made without departing from the principles of the present disclosure, and these improvements and modifications are regarded as the scope of protection of the present disclosure.

What is claimed is:

1. A data processing method performed by a first processor of a first device, the method comprising:
in response to the first device and a second device being in a connected state, loading a second model stored in the second device to a second processor of the second device, wherein the second model running on the second processor processes data output by the first device.

2. The method of claim 1, further comprising:
identifying a first model stored in the first device, a function of the first model and a function of the second model meet a condition; and
setting the first model to a disabled state.

3. The method of claim 2, wherein identifying the first model stored in the first device includes:
determining a model name of the first model is same as a model name of the second model.

4. The method of claim 2, further comprising:
in response to the first device and the second device switching from the connected state to a non-connected state, setting the first model to an enabled state; and
loading the first model to process the data of the first device.

5. The method of claim 1, wherein the second device includes an adapter and a second memory in addition to the second processor, the adapter is used to convert a first protocol to a second protocol, and the method further comprises:
connecting to the adapter through an interface supporting the first protocol, and connecting to the second memory and the second processor through the adapter;
communicating with the second memory using the first protocol; and
communicating with the second processor using the second protocol.

6. The method of claim 1, wherein loading the second model to the second processor includes:
sending a first instruction to the second device, so that a second memory of the second device is in a first power consumption mode, and the second processor of the second device is in a second power consumption mode, and a power consumption corresponding to the first power consumption mode is greater than a power consumption corresponding to the second power consumption mode; and
causing the second model stored in the second memory to be read into the first memory of the first device.

7. The method of claim 1, wherein loading the second model to the second processor includes:
sending a second instruction to the second device, so that the second memory is in a second power consumption mode and the second processor is in a first power consumption mode, and a power consumption corresponding to the first power consumption mode is greater than a power consumption corresponding to the second power consumption mode; and
causing the second model to be written to a cache of the second processor.

8. The method of claim 1, further comprising:
causing the second model to be updated to obtain an updated second model; and
loading the updated second model into the second processor.

9. The method of claim 1, further comprising:
in response to the first device and the second device being in the connected state, setting a second memory of the second device to a non-editable state;
causing the second model to be updated to obtain an updated second model;
setting the second memory to an editable state;
replacing the second model stored in the second memory with the updated second model; and
setting the second memory back to the non-editable state.

10. The method of claim 1, wherein the second device further includes a third processor, the third processor is used to run a control system, and the method further comprises:
sending a third instruction to the third processor, so that the control system loads the second model to the second processor according to the third instruction.

11. A first electronic device comprising: a first memory storing computer program instructions; and a first processor coupled to the first memory and configured to execute the computer program instructions and perform:
in response to the first device and a second device being in a connected state, loading a second model stored in the second device to a second processor of the second device, wherein the second model running on the second processor processes data output by the first device.

12. The first electronic device of claim 11, wherein the first processor is further configured to perform:
identifying a first model stored in the first device, a function of the first model and a function of the second model meet a condition; and
setting the first model to a disabled state.

13. The first electronic device of claim 12, wherein identifying the first model stored in the first device includes:
determining a model name of the first model is same as a model name of the second model.

14. The first electronic device of claim 12, wherein the first processor is further configured to perform:
in response to the first device and the second device switching from the connected state to a non-connected state, setting the first model to an enabled state; and
loading the first model to process the data of the first device.

15. The first electronic device of claim 11, wherein the second device includes an adapter and a second memory in addition to the second processor, the adapter is used to convert a first protocol to a second protocol, and the first processor is further configured to perform:
connecting to the adapter through an interface supporting the first protocol, and connecting to the second memory and the second processor through the adapter;
communicating with the second memory using the first protocol; and
communicating with the second processor using the second protocol.

16. The first electronic device of claim 11, wherein loading the second model to the second processor includes:
sending a first instruction to the second device, so that a second memory of the second device is in a first power consumption mode, and the second processor of the second device is in a second power consumption mode, and a power consumption corresponding to the first power consumption mode is greater than a power consumption corresponding to the second power consumption mode; and
causing the second model stored in the second memory to be read into the first memory of the first device.

17. The first electronic device of claim 11, wherein loading the second model to the second processor includes:
sending a second instruction to the second device, so that the second memory is in a second power consumption mode and the second processor is in a first power consumption mode, and a power consumption corresponding to the first power consumption mode is greater than a power consumption corresponding to the second power consumption mode; and
causing the second model to be written to a cache of the second processor.

18. The first electronic device of claim 11, wherein the first processor is further configured to perform:
causing the second model to be updated to obtain an updated second model; and
loading the updated second model into the second processor.

19. The first electronic device of claim 11, wherein the first processor is further configured to perform:
in response to the first device and the second device being in the connected state, setting a second memory of the second device to a non-editable state;
causing the second model to be updated to obtain an updated second model;
setting the second memory to an editable state;
replacing the second model stored in the second memory with the updated second model; and
setting the second memory back to the non-editable state.

20. A non-transitory computer-readable storage medium storing computer program instructions executable by at least one processor to perform:
in response to a first device and a second device being in a connected state, loading a second model stored in the second device to a second processor of the second device, wherein the second model running on the second processor processes data output by the first device.
